(19) United States
(12) Patent Application Publication
(10) Pub. No.: US 2014/0285419 A1
(43) Pub. Date: Sep. 25, 2014

(54) DISPLAY APPARATUS EQUIPPED WITH MOTION DETECTION SENSOR

(71) Applicants: He Won Jung, Ansan-si (KR); Jun Sam Choi, Ansan-si (KR); Gi Hong Kim, Ansan-si (KR)

(72) Inventors: He Won Jung, Ansan-si (KR); Jun Sam Choi, Ansan-si (KR); Gi Hong Kim, Ansan-si (KR)

(73) Assignee: HYSONIC. CO., LTD., Ansan-si (KR)

(21) Appl. No.: 13/983,130

(22) PCT Filed: Sep. 25, 2012
(86) PCT No.: PCT/KR2012/007700

§ 371 Date: Aug. 1, 2013

(30) Foreign Application Priority Data
Nov. 30, 2011 (KR) 10-2011-0127154

(51) Int. Cl. G06F 3/01

(52) U.S. Cl. CPC G06F 3/011; G06F 2203/01
USPC 345/156

(57) ABSTRACT

Disclosed is a display apparatus which is driven by a motion detection sensor, and more particularly, to a display apparatus in which power, volume, channel or the like are controlled by a motion detection sensor. The display apparatus of the present invention includes a display part which displays an image; a support stand which supports the display part; a power source which supplies power to the display part; a motion detection sensor which is installed at an edge surface of the display part so as to detect an operation signal of an object in a contactless manner; and a main control part which controls the display part based on a detection signal from the motion detection sensor, wherein the motion detection sensor is installed so as to be oriented toward an outer surface of the display part, thereby detecting a motion signal at the outer surface of the display part. According to the present invention, since the frame part such as a bezel of the display part is not needed, the display screen can be expanded by a width of the bezel part. Further, since about 5 to 10% of the outer size of the display part corresponding to the width of the bezel part can be reduced, it is advantageous in the space usage.

### TECHNICAL FIELD

The present invention relates to a display apparatus which is driven by a motion detection sensor, and more particularly, to a display apparatus in which power, volume, channel or the like are controlled by a motion detection sensor.

### BACKGROUND ART

Generally, a display apparatus is to display image information through a display module such as a cathode ray tube, a liquid crystal panel, an electroluminescence panel and a plasma display panel.

When controlling power, volume, channel or the like in a general display apparatus, a user performs the controlling using operating buttons provided on a front surface of the display apparatus or using a remote control at a certain distance.

Recently, there has been developed a contactless control signal input device which can control the volume and channel of a display apparatus in an audio system, TV, a monitor or the like. The contactless control signal input device employs a sensor module such as an infrared proximity sensor module comprised of an infrared light receiving element and an infrared light emitting element, an ultrasonic proximity sensor module using an ultrasonic transducer comprised of a receiver, and a proximity sensor module using a high-frequency oscillation-type proximity switch.

In most of the sensor modules used in the contactless control signal input device, a transmitting and receiving source is disposed to be oriented to a front side or in a diagonal direction of a display part of the display apparatus.

For example, in Korean Patent Laid-Open No. 10-2004-0000845 (published on Jan. 7, 2004 entitled “Contactless method and apparatus for controlling a control unit by detecting finger moving direction and distance”, there is disclosed a display apparatus using the above-mentioned sensors.

In this published document, a control unit controlling device is provided in order to operate various units in a vehicle without any hand contact. However, there is a disadvantage in that the various motion detection sensors used in such device have to be oriented to a driver in order to detect a finger moving direction of the user.

### Disclosure

### Technical Problem

An object of the present invention is to provide a display apparatus in which the volume and channel can be controlled by using only a motion detection sensor without button operations of the display apparatus or remote control, and thus anyone who is wounded or disabled on fingers can facilely control the power, volume and/or channel of the display apparatus.

Another object of the present invention is to provide a display apparatus in which a separate front space of a display part for mounting power, volume and channel operating buttons is not needed, and thus it is possible to expand a display screen.

Yet another object of the present invention is to provide a display apparatus which can control the power, volume and channel in a contactless manner without any trial and error.

### Technical Solution

To achieve the object of the present invention, the present invention can provide a display apparatus equipped with a motion detection sensor, including a display part which displays an image; a support stand which supports the display part; a power source which supplies power to the display part; a motion detection sensor which is installed at an edge surface of the display part so as to detect an operation signal of an object in a contactless manner; and a main control part which controls the display part based on a detection signal from the motion detection sensor, wherein the motion detection sensor is installed so as to be oriented toward an outer surface of the display part, thereby detecting a motion signal at the outer surface of the display part.

Preferably, the motion detection sensor comprises a motions detection sensor for power supply, a motions detection sensor for volume control and a motion detection sensor for channel control, and the motions detection sensor for power supply detects a motion signal of an object and transmits it to the main control part in order to switch on/off power, and the motions detection sensor for volume control and the motion detection sensor for channel control detect the operation signal of the object and transmit it to the main control part in order to control volume and channel.

Preferably, the motion detection sensor is installed at the edge surface of the display part opposed to a floor or at a rear side thereof so as to transmit light and detect light reflected and detected, thereby detecting proximity or moving direction of the object.

Preferably, part or all of the motion detections sensors comprise(s) a base which is installed at the edge surface of the display part; a light receiving element which is installed at the base; multiple light emitting elements which are disposed at the base so as to be symmetric with respect to the light receiving element and spaced part from each other; and a motion detection sensor controlling part which operates the light emitting elements, and the light emitting elements are disposed to be inclined in an opposite direction to the light receiving element, and the light receiving element detects light emitted from the light emitting elements and reflected by a reflecting body and then transmits an operation signal to the motion detection sensor controlling part, and the motion detection sensor controlling part receives the operation signal and recognizes a motion of the reflecting body.

Preferably, the base comprises a plane portion on which the light receiving element is installed; and an inclined portion which is formed to be inclined toward an outside of the plane portion and in which the light emitting elements are installed. And a partition wall is formed between the plane portion and the inclined portion to be protruded.

Preferably, the inclined portion is comprised of 4 parts which are arranged at angular intervals of 90° with the plane portion 110 in the center, and the partition wall is disposed to enclose an outside of the light receiving element, such that a surface of each partition wall is corresponding to each inclined portion, and a transparent cover which is disposed to cover the light receiving element and through which the light reflected by the reflecting body is penetrated is coupled to an upper portion of the partition wall, and the inclined portions are formed to be inclined at the same angle so that each light emitting element is disposed therein to be inclined at the same angle.

Preferably, an LED for informing the position of the motion detection sensor is installed at a portion that the motion detection sensor is installed, and the main control part turns on the LED when the motion detection sensor detects a motion signal of the object.

### Advantageous Effects

According to the present invention, since the volume and channel can be controlled by using only the motion detection sensor without button operations of the display apparatus or remote control, anyone who is wounded or disabled on fingers can facilely control the power, volume and/or channel of the display apparatus.

Further, since the separate front space of the display part for mounting the power, volume and channel operating buttons is not needed, it is possible to expand a display screen.

That is, according to the present invention, since the frame part such as a bezel of the display part is not needed, the display screen can be expanded by a width of the bezel part. Further, since about 5 to 10% of the outer size of the display part corresponding to the width of the bezel part can be reduced, it is advantageous in the space usage.

### DESCRIPTION OF DRAWINGS

The above and other objects, features and advantages of the present invention will become apparent from the following description of preferred embodiments given in conjunction with the accompanying drawings, in which:

FIG. 1 is a schematic view showing a main part of a display apparatus according to an embodiment of the present invention.

FIG. 2 is a view of the display apparatus of FIG. 1 when viewing at other angle.

FIG. 3 is a block diagram showing the process of detecting a proximity state or a moving direction of an object in the display apparatus, turning on/off power, controlling volume and turning a channel according to the present invention.

FIG. 4 is a perspective view of a motion detection sensor which can be used in the display apparatus according to the embodiment of the present invention.

FIG. 5 is an exploded perspective view of the motion detection sensor which can be used in the display apparatus according to the embodiment of the present invention.

FIG. 6 is a cross-sectional view taken along a line A-A of FIG. 4.

FIG. 7 is a cross-sectional view taken along a line B-B of FIG. 4.

FIG. 8 is a view showing a light emitting angle emitted from a light emitting element of the motion detection sensor which can be used in the display apparatus according to the embodiment of the present invention.

FIG. 9 is a view showing the distribution of light when viewing at a height D1 of FIG. 8.

FIG. 10 is a view showing the distribution of light when viewing at a height D2 of FIG. 8.

### BEST MODE

Hereinafter, the embodiments of the present invention will be described in detail with reference to accompanying drawings. The same reference numerals are given to the same or corresponding parts, and the description thereof will not be repeated.

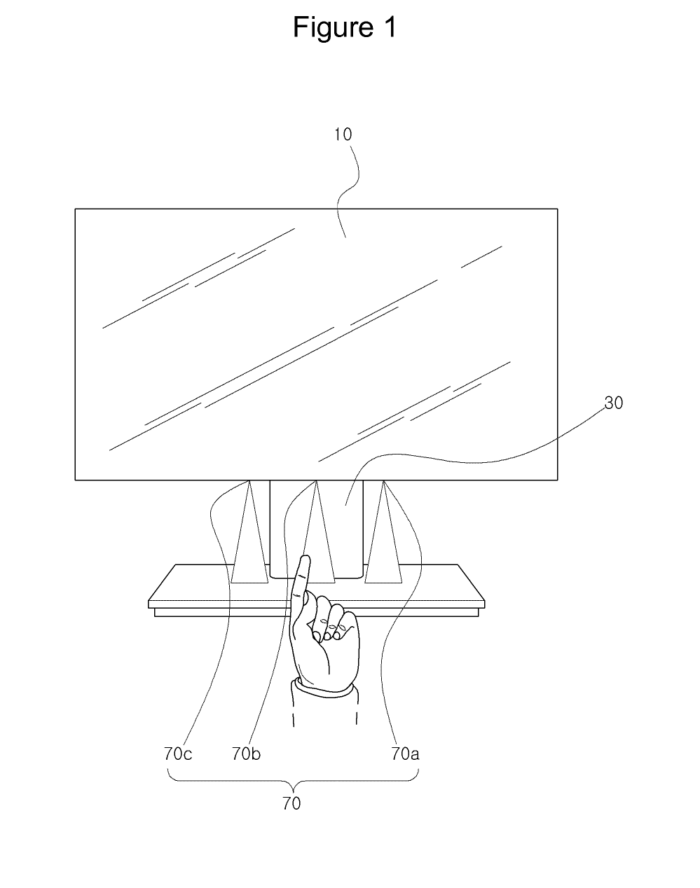

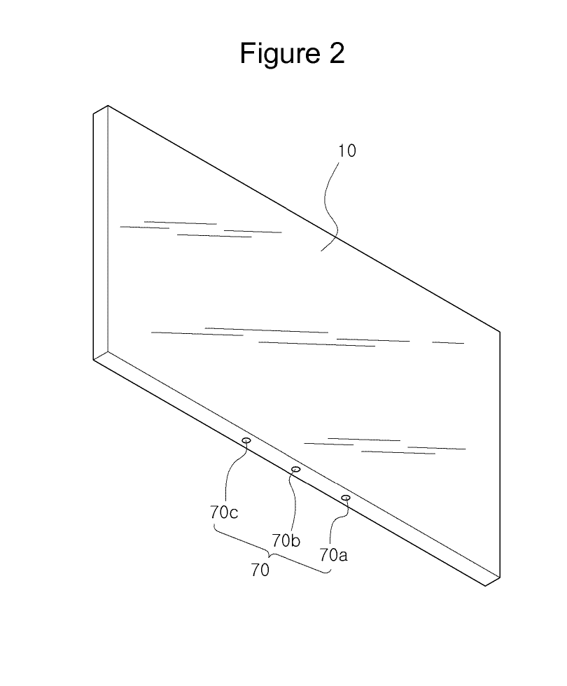

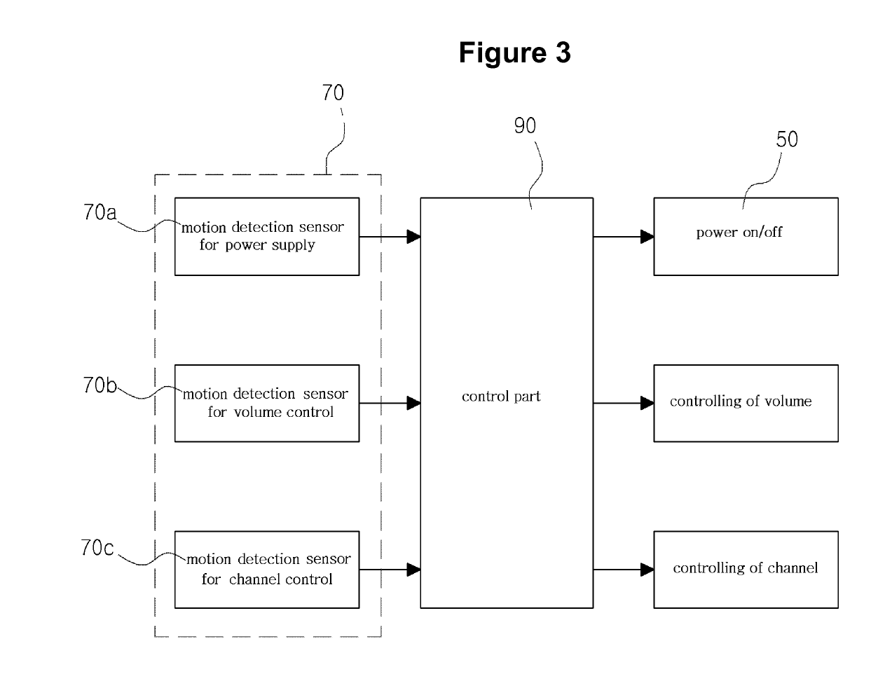

FIG. 1 is a schematic view showing a main part of a display apparatus according to an embodiment of the present invention, FIG. 2 is a view of the display apparatus of FIG. 1 when viewing at other angle, and FIG. 3 is a block diagram showing the process of detecting a proximity state or a moving direction of an object in the display apparatus, turning on/off power, controlling volume and turning a channel according to the present invention.

Referring to FIGS. 1 and 2, a display apparatus according to an embodiment of the present invention includes a display part 10, a support stand 30, a power source part 50, a motion detection sensor 70 and a main control part 90.

The display part 10, such an LCD panel and an LED panel, functioning to display an image is already well known in the art.

The support stand 30 for supporting the display part 10 is installed at a lower side of the display part 10. In the embodiment, the support stand 30 is configured to be installed at the lower side of the display part 10 and put on a floor. However, in the light of space usage, the support stand 30 may be installed at an upper side of the display part 10 and put on a ceiling, or the display part 10 may be directly installed on a wall.

The power source part 50 is to supply power to the display part. Further, the power source part 50 is controlled by the main control part 90 which receives a desired command based on a detecting signal from a motion detection sensor for power supply and controls the display part 10.

Multiple motion detection sensors 70 which detect a motion signal of an object, e.g., a proximity signal and/or a moving directional signal of the object are disposed at an edge surface of the display part 10 or a rear side thereof.

Herein, as shown in FIG. 2, the multiple motion detection sensors 70 are oriented toward an outer surface of the display part 10 so as to detect a motion signal at the outer surface of the display part 10.

In the embodiment, in the light of the space usage and user's height and in order to minimize influences of external factors, the multiple motion detection sensors 70 are disposed at the edge surface of the display part 10 which is opposed to a floor. However, the motion detection sensors 70 may be disposed at other edge surface of the display part 10 or the rear side thereof, i.e., at a side or upper edge surface or the rear side thereof.

The motion detection sensors 70 include a motion detection sensor 70a for power supply, which detects the proximity or moving direction of an object. Further, the motion detection sensors 70 include a motion detection sensor 70b for volume control and a motion detection sensor 70c for channel control, which detect the moving direction of the object.

Referring to FIG. 3, the motion detection sensor 70a for power supply, which is installed at the edge surface of the display part 10 opposed to the floor or the rear side thereof, detects the proximity or movement of an object to the lower side of the display part 10, e.g., the proximity of a user or user's hand or the movement of the user's hand in a specific or non-specific direction and transmits it to the main control part 90, and the main control part 90 operates the power source part 50 based on the detected signal.

Moreover, in the state that the power source part 50 of the display part 10 is turned on, the motion detection sensor 70b for volume control and the motion detection sensor 70c for channel control detect a motion signal of an object, e.g., a motion signal that the object is moved from a left side to a right side at a lower space of the display part 10 and then transmits it to the main control part 90. The main control part 90 turns up the volume or turns the channel according to a predetermined value based on the detected signal. Various types that the main control part is operated on the basis of the signal detected from each of the motion detection sensors 70 may be proposed by a person skilled in the art.

The motion detection sensor used in the present invention may be an infrared detection sensor, an ultrasonic detection sensor or an optical detection sensor. The motion detection sensor according to one embodiment of the present invention is installed at the edge surface of the display part 10 opposed to the floor or the rear side thereof and transmits light to the floor and then receives the reflected light, thereby detecting the proximity or moving direction of an object.

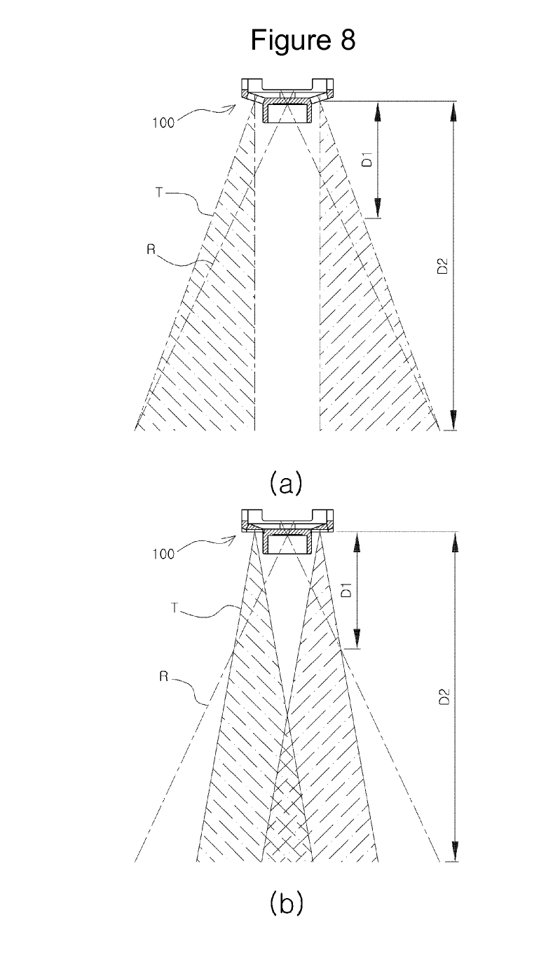

Hereinafter, the motion detection sensor which transmits light and then receives the reflected light will be described. The display apparatus equipped with such type motion detection sensor is also included in the scope of the present invention. Further, the motion detection sensor to be referred below may be one of the above-mentioned motion detection sensors or all of them. And in the motion detection sensor to be described and shown below, an upper portion of each drawing except FIG. 8 is considered to be oriented to the floor. That is, the description below will be just described with reference to drawings and the upper portion of each drawing is regarded to be oriented to the floor.

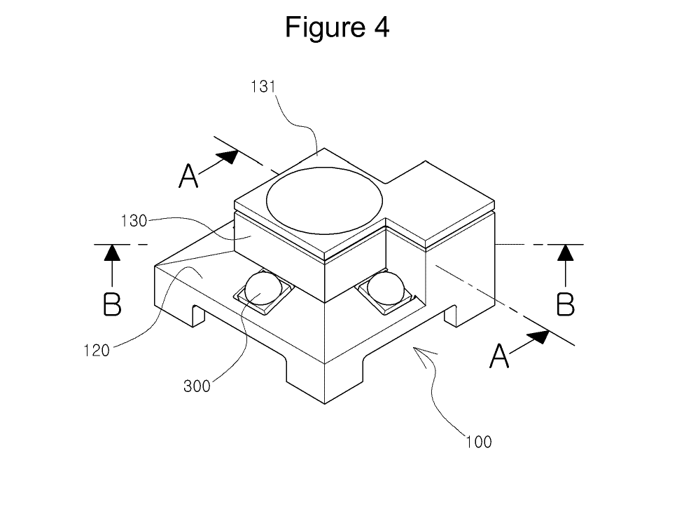

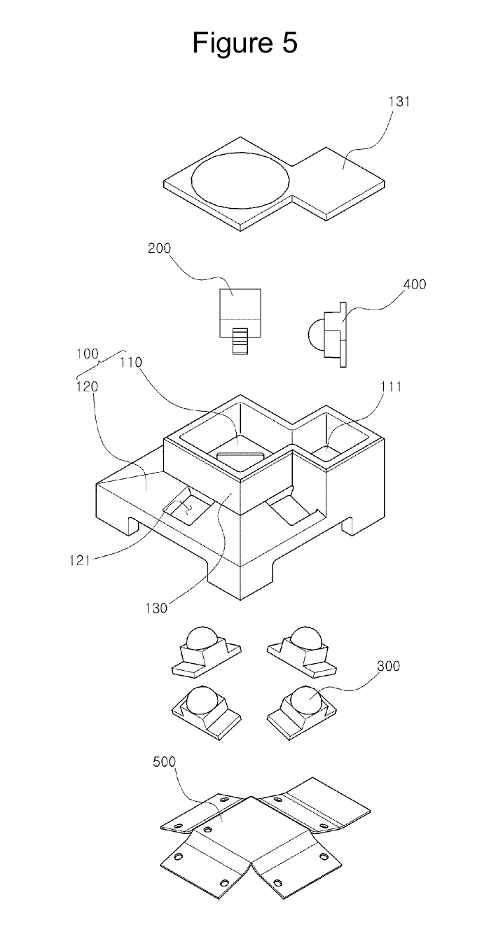

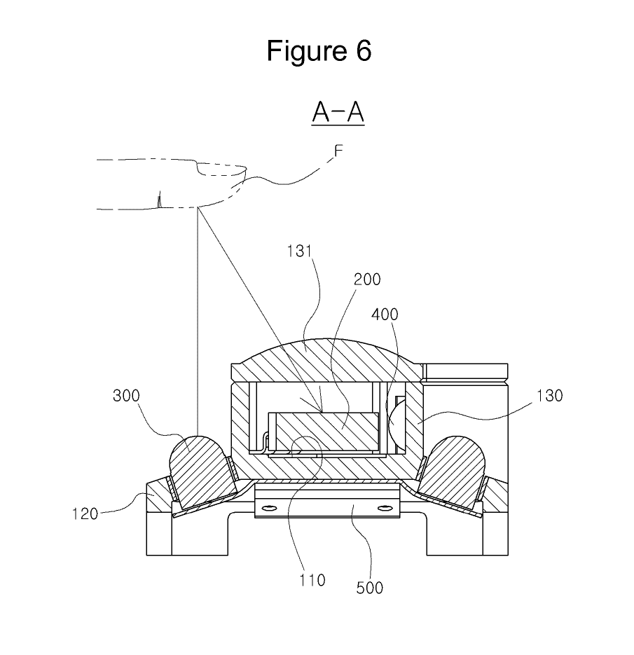

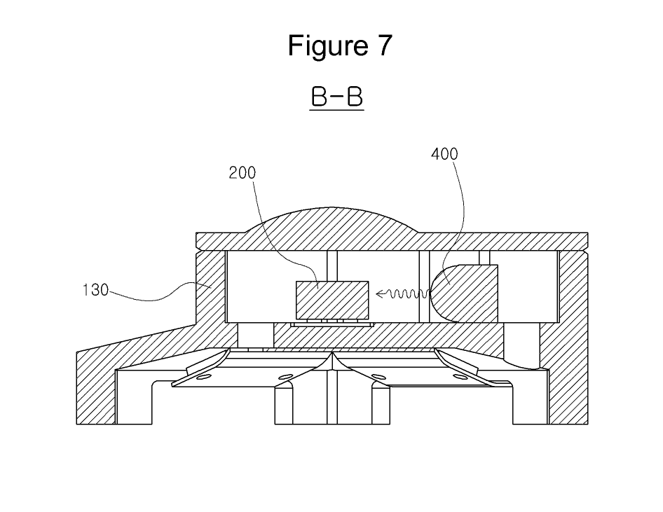

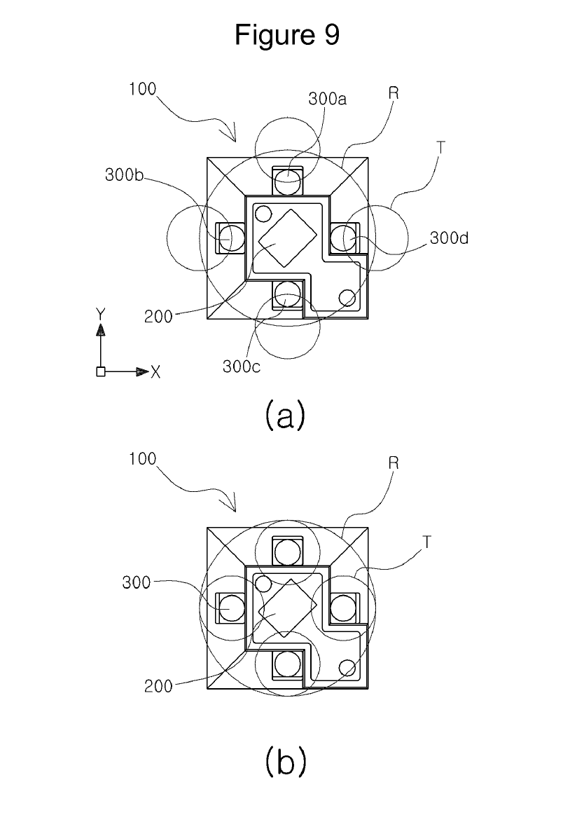

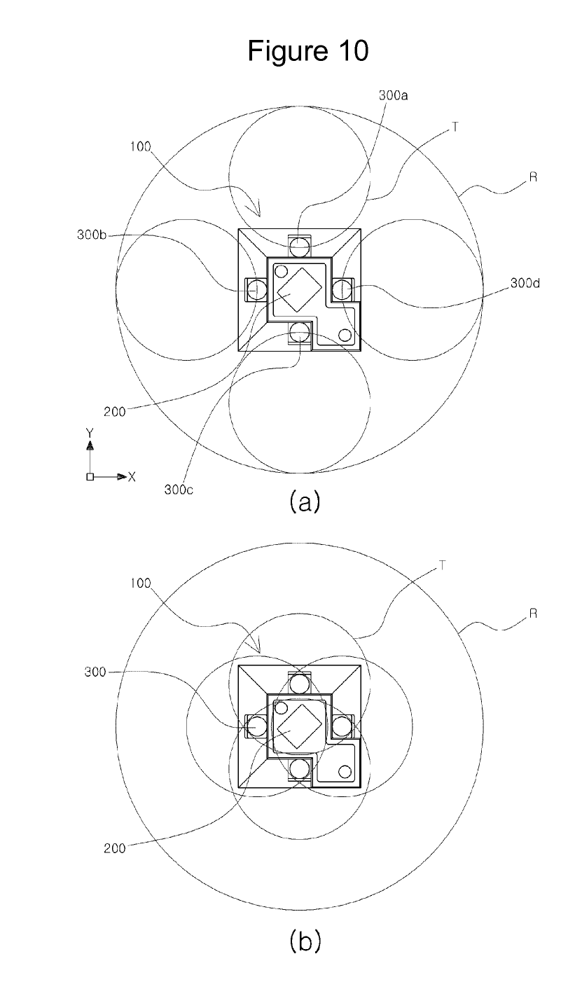

FIG. 4 is a perspective view of a motion detection sensor which can be used in the display apparatus according to the embodiment of the present invention, FIG. 5 is an exploded perspective view of the motion detection sensor which can be used in the display apparatus according to the embodiment of the present invention, FIG. 6 is a cross-sectional view taken along a line A-A of FIG. 4, FIG. 7 is a cross-sectional view taken along a line B-B of FIG. 4, FIG. 8a is a view showing a light emitting angle emitted from a light emitting element of the motion detection sensor which can be used in the display apparatus according to the embodiment of the present invention, FIG. 8b is a view showing a light emitting angle emitted from the light emitting element mounted on an inclined portion which is formed to be parallel to a plane portion, FIG. 9a is a view showing the distribution of light when viewing at a height D1 of FIG. 8a, FIG. 9b is a view showing the distribution of light when viewing at a height D1 of FIG. 8b, FIG. 10a is a view showing the distribution of light when viewing at a height D2 of FIG. 8a, and FIG. 10b is a view showing the distribution of light when viewing at a height D2 of FIG. 8b.

As shown in FIGS. 4 to 7, the motion detection sensor which can be used in the display apparatus according to an embodiment of the present invention includes a base 100, a light receiving element 200, a light emitting element 300, a compensation element 400, a circuit board 500 and a motion detection sensor controlling part (not shown).

The base 100 is installed at an edge surface of the display part 10 opposed to a floor or a rear side thereof.

The base 100 includes a plane portion 110 and an inclined portion 120.

As shown in FIGS. 5 and 6, the light receiving element 200 is installed at the the plane portion 110.

An installed portion 111 in which the compensation element 400 is installed is formed at a side portion of the plane portion 110.

As shown in FIGS. 4 to 6, the inclined portion 120 is formed to be inclined toward an outside of the plane portion 110, i.e., inclined downward in drawings, and the light emitting element 300 is inclinedly installed thereon.

Detailedly, the inclined portion 120 is comprised of 4 parts which are arranged at angular intervals of 90° with the plane portion 110 in the center. In the embodiment, the inclined portion 120 is comprised of 4 parts, but in case of the motion detection sensor 70a, when detecting only the proximity of an object, the inclined portion 120 may be comprised of 1 part, and for example, when detecting the left and right movement of an object, the inclined portion 120 may be comprised of at least 2 parts.

The inclined portion 120 is formed to be inclined at the same angle toward the outside of the plane portion 110, i.e., inclined downward in drawing.

The inclined portion 120 is formed with a coupling hole 121 which passes through up and down.

The light emitting element 300 is coupled in the coupling hole 121 so as to be inclined with respect to the inclined portion 120.

FIG. 8 schematically shows only the base 100 in order to check an angle of light emitted from the light emitting element 300.

FIG. 8a shows a light emitting and receiving angle emitted in the motion detection sensor, and FIG. 8b shows a light emitting and receiving angle in the motion detection sensor in which the inclined portion 120 is disposed to be parallel with the plane portion.

Substantially, as shown in FIG. 8, although the light emitted from the light emitting element 300 is not emitted straightly but emitted in a streamline shape, it is simply shown in a straight line shape.

When comparing FIGS. 8a and 8b, the light emitted from the light emitting element 300 mounted on the inclined portion 120 which is formed to be inclined toward the outside of the plane portion 110, i.e., inclined upward in drawing is emitted to be inclined in an opposite direction to the light receiving element 200 mounted on the plane portion 110.

As shown in FIG. 9, since the light emitted from each light emitting element 300 is not overlapped within a distance D1 from the motion detection sensor, the motion detection sensor controlling part (not shown) can facilely distinguish the light which is emitted from the light emitting element 300 and then reflected by a reflecting body F.

However, as shown in FIG. 10b, in case of the reflecting body F which is moved over the distance D1 from the motion detection sensor in which the inclined portion 120 is parallel with the plane portion 110. A light emitting range T emitted from each light emitting element 300 is partially overlapped with each other within a light receiving range R of the light receiving element 200.

If the reflecting body F is moved in the portion that the light emitting range T emitted from each light emitting element 300 is partially overlapped with each other, it is difficult for the motion detection sensor controlling part to distinguish from which light emitting element 300 the light reflected by the reflecting body F and detected by the light receiving element 200 is emitted, and thus it is difficult to confirm a position and movement of the reflecting body F.

However, in the embodiment, the inclined portion 120 is formed to be inclined with respect to the plane portion 110, and the light emitting element 300 is installed at the inclined portion 120 so as to emit light, and thus as shown in FIG. 10a, the light emitting range T emitted from each light emitting element 300 is not overlapped each other even within the distance D2 over D1. Therefore, it is facile to distinguish from which light emitting element 300 the light detected by the light receiving element 200 is emitted, and it is possible to sensitively detect the position and movement of the reflecting body F.

As described above, since the inclined portion 120 is formed to be inclined with respect to the plane portion 110 so that the light is emitted from the light emitting element 300, it is possible to minimize the motion detection sensor and also sensitively detect the position and movement of the reflecting body F at long range.

The distance D1, D2 between the motion detection sensor and the reflecting body F is changed according to the inclined angle of the inclined portion 120 and the light emitting angle emitted from the light emitting element 300.

A partition wall 130 is formed to be protruded between the plane portion 110 and the inclined portion 120.

As shown in FIGS. 5 to 7, the partition wall 130 is disposed to be corresponding to the inclined portion 120 while enclosing outside the light receiving element 200.

Further, the partition wall 130 is also disposed to enclose an outside of the compensation element 400.

Therefore, the light receiving element 200 and the compensation element 400 are disposed inside the partition wall 130.

A transparent cover 131 which is disposed to cover the light receiving element 200 and through which the light reflected by the reflecting body F is penetrated is coupled to an upper portion of the partition wall 130.

The light receiving element 200 is installed at the base 100.

That is, the light receiving element 200 is installed at the plane portion 110 so as to be enclosed by the partition wall 130.

The light receiving element 200 does not directly detect light which is emitted from the light emitting element 300 but not reflected by the reflecting body F, but detects only light which is emitted from the light emitting element 300 and reflected by the reflecting body F and then transmits an operation signal to the motion detection sensor controlling part.

Therefore, it is prevented that the light receiving element 200 detects the light which is not reflected by the reflecting body F and thus there is confusion in that the motion detection sensor controlling part recognizes a motion of the reflecting body F.

Detailedly, the light receiving element 200 is comprised of a photodiode which generates current when detecting light.

The current generated from the light receiving element 200, as the operation signal, is transmitted to the motion detection sensor controlling part.

The light emitting element 300 is disposed at the base 100 so as to be symmetric with respect to the light receiving element 200.

Four light emitting elements 300 are respectively coupled to the coupling hole 121 formed in the inclined portion 120 so as to be inclined in the opposite direction to the light receiving element 200.

And each of the light emitting elements 300 is disposed to be inclined at the same angle.

If necessary, as described above, the inclined portion 120 may be formed to be parallel with the plane portion 110, and then the light emitting element 300 may be installed at the inclined portion 120 so as to be inclined.

The light emitting element 300 is an IR (Infrared Rays) LED which emits infrared light.

The infrared light emitted from the light emitting element 300 is reflected to the light receiving element 200 by the reflecting body F which is moved at a lower side of the motion detection sensor, i.e., an upper side in drawing.

The reflecting body F may be user's body or various tools which are moved by the user in order to operating an apparatus equipped with the motion detection sensor.

The compensation element 400 is installed at the installed portion 111 so as to emit the infrared light to the light receiving element 200.

As shown in FIG. 7, since the compensation element 400 is installed together with the light receiving element 200 inside the partition wall 130 so as to be oriented toward the light receiving element 200, the light receiving element 200 can directly detect the light emitted from the compensation element 400.

As described above, the compensation element 400 emits light to the light receiving element 200 and thus the operation signal generated at the light receiving element 200 is compensated by the light emitted from the light emitting element 300 and reflected by the reflecting body F.

Detailedly, the compensation element 400 emits the light so that the light receiving element 200 detects a desired amount of light according to a brightness of the surrounding environment detected by a separate sensor (not shown).

That is, since the environmental change such as indoor lighting, outdoor weather and tunnel occurs the change in a light source, the compensation element 400 emits the light according to an amount of external light.

The circuit board 500 is coupled to a rear portion of the base 100 and electrically connected with the light receiving element 200, light emitting element 300 and the compensation element 400, and the motion detection sensor controlling part is mounted thereon.

The motion detection sensor controlling part operates the light emitting element 300.

As described above, the motion detection sensor controlling part is mounted on the circuit board 500 and allows the light emitting element 300 to emit the light.

As described later, the motion detection sensor controlling part operates repeatedly the four light emitting elements 300 in turn.

Hereinafter, an operational method of the motion detection sensor as described above will be described.

The motion detection sensor controlling part turns on and off repeatedly the light emitting elements 300, in turn, so as to emit the light to the lower side of the motion detection sensor.

Since the light emitting elements 300 is turned on and off in turn, the motion detection sensor controlling part can facilely distinguish the light emitted from the light emitting elements 300.

The light emitted from one of the light emitting elements 300 is reflected by the reflecting body F and then detected by the light receiving element 200, and the intensity of light reflected by the reflecting body F is changed according to the movement of the reflecting body F.

While the intensity of light emitted from one of the light emitting elements 300 and reflected by the reflecting body F is changed, the light emitted from the rest light emitting elements 300 is not reflected by the reflecting body F and thus not detected by the light receiving element 200, or even though the light emitted from the rest light emitting elements 300 is reflected by the reflecting body F and thus detected by the light receiving element 200, the change in the intensity of light is small. Therefore, the motion detection sensor controlling part can distinguish the light emitting element 300, from which the light reflected by the reflecting body F and detected by the light receiving element 200 is emitted, according to the current generated by the light detected by the light receiving element 200, i.e., a change in the intensity of operation signal.

Therefore, the motion detection sensor controlling part can confirm the position and movement of the reflecting body F.

In other words, the light receiving element 200 detects the light reflected by the reflecting body F and transmits the operation signal to the motion detection sensor controlling part, and the motion detection sensor controlling part analyzes the intensity and characteristic of the operation signal and confirms the position and movement of the reflecting body F and then operates the apparatus equipped with the motion detection sensor according to the motion of the reflecting body F.

More detailedly, as shown in FIGS. 9 and 10, the light emitting element 300 includes a first light emitting element 300a, a second light emitting element 300b, a third light emitting element 300c and a fourth light emitting element 300d. If the reflecting body F is moved from the side of the first light emitting element 300a to the side of the third light emitting element 300c, the intensity of light emitted from the first light emitting element 300a and detected by the light receiving element 200 becomes larger and then smaller, and the intensity of light emitted from the third light emitting element 300c and detected by the light receiving element 200 becomes larger and then smaller.

The light receiving element 200 generates the operation signal according the change in the intensity of light emitted from the first and third light emitting elements 300a and 300c, and the motion detection sensor controlling part receives the operation signal, thereby recognizing the fact that the reflecting body is moved in a y axial direction, i.e., from the side of the first light emitting element 300a to the side of the third light emitting element 300c.

Meanwhile, when the reflecting body is moved from the side of the third light emitting element 300c to the side of the first light emitting element 300a, the intensity of light emitted from the third light emitting element 300c is firstly changed and then the intensity of light emitted from the first light emitting element 300a is changed.

Further, if the reflecting body is moved from the side of the second light emitting element 300b to the side of the fourth light emitting element 300d, the intensity of light emitted from the second light emitting element 300b and detected by the light receiving element 200 becomes larger and then smaller, and the intensity of light emitted from the fourth light emitting element 300d and detected by the light receiving element 200 becomes larger and then smaller.

Therefore, the motion detection sensor controlling part can recognize the fact that the reflecting body F is moved in an x axial direction.

And the movement of the reflecting body F in a z axial direction, i.e., the up/down movement of the reflecting body can be recognized according to the intensity of light emitted from the light emitting element 300 and reflected by the reflecting body F and then detected by the light receiving element 200.

That is, as a distance between the reflecting body F and the light receiving element 200 becomes larger, the intensity of light detected by the light receiving element 200 becomes weaker, and as the distance between the reflecting body F and the light receiving element 200 becomes smaller, the intensity of light detected by the light receiving element 200 becomes stronger.

The motion detection sensor controlling part can recognize the movement of the reflecting body F in three dimensions and can operate the apparatus equipped with the motion detection sensor according to the movement of the reflecting body F.

In the motion detection sensor as described above, the inclined portion 120 is formed to be inclined with respect to the plane portion 110, and the light emitting element 300 is installed at the inclined portion 120 so that the light emitted from the light emitting element 300 is emitted so as to be inclined in the opposite direction to the light receiving element 200. Therefore, even though the reflecting body F is moved away from the motion detection sensor, it is minimized that the light emitting range T emitted from each light emitting element 300 is overlapped with each other, and thus it is possible to sensitively detect the motion of the reflecting body F at long range while minimizing the size of the motion detection sensor.

Further, according to the present invention, an LED for informing the position of the motion detection sensor may be installed at the part that the motion detection sensor is installed. Herein, the main control part turns on the LED when the motion detection sensor detects the motion signal of an object.

### Industrial Applicability

The present invention can be applied to a display apparatus, such that the power, volume and channel can be controlled by using only the motion detection sensor without button operations of the display apparatus or remote control, and thus anyone who is wounded or disabled on fingers can facilely control the power, volume and/or channel of the display apparatus.

While the present invention has been described with respect to the specific embodiments, it will be apparent to those skilled in the art that various changes and modifications may be made without departing from the spirit and scope of the invention as defined in the following claims.

1. A display apparatus equipped with a motion detection sensor, comprising:
a display part which displays an image;
a support stand which supports the display part;
a power source which supplies power to the display part;
a motion detection sensor which is installed at an edge surface of the display part so as to detect an operation signal of an object in a contactless manner; and
a main control part which controls the display part based on a detection signal from the motion detection sensor,
wherein the motion detection sensor is installed so as to be oriented toward an outer surface of the display part, thereby detecting a motion signal at the outer surface of the display part.

2. The display apparatus according to claim 1, wherein the motion detection sensor comprises a motions detection sensor for power supply, a motions detection sensor for volume control and a motion detection sensor for channel control, and
the motions detection sensor for power supply detects a motion signal of an object and transmits it to the main control part in order to switch on/off power, and the motions detection sensor for volume control and the motion detection sensor for channel control detect the operation signal of the object and transmit it to the main control part in order to control volume and channel.

3. The display apparatus according to claim 1, wherein the motion detection sensor is installed at the edge surface of the display part opposed to a floor or at a rear side thereof so as to transmit light and detect light reflected and detected, thereby detecting proximity or moving direction of the object.

4. The display apparatus according to claim 1, wherein part or all of the motion detections sensors comprise(s) a base which is installed at the edge surface of the display part; a light receiving element which is installed at the base; multiple light emitting elements which are disposed at the base so as to be symmetric with respect to the light receiving element and spaced part from each other; and a motion detection sensor controlling part which operates the light emitting elements, and
the light emitting elements are disposed to be inclined in an opposite direction to the light receiving element, and
the light receiving element detects light emitted from the light emitting elements and reflected by a reflecting body and then transmits an operation signal to the motion detection sensor controlling part, and
the motion detection sensor controlling part receives the operation signal and recognizes a motion of the reflecting body.

5. The display apparatus according to claim 4, wherein the base comprises a plane portion on which the light receiving element is installed; and an inclined portion which is formed to be inclined toward an outside of the plane portion and in which the light emitting elements are installed.

6. The display apparatus according to claim 5, wherein a partition wall is formed between the plane portion and the inclined portion to be protruded.

7. The display apparatus according to claim 6, wherein the inclined portion is comprised of 4 parts which are arranged at angular intervals of 90° with the plane portion 110 in the center, and
the partition wall is disposed to enclose an outside of the light receiving element, such that a surface of each partition wall is corresponding to each inclined portion, and
a transparent cover which is disposed to cover the light receiving element and through which the light reflected by the reflecting body is penetrated is coupled to an upper portion of the partition wall, and
the inclined portions are formed to be inclined at the same angle so that each light emitting element is disposed therein to be inclined at the same angle.

8. The display apparatus according to claim 1, wherein an LED for informing the position of the motion detection sensor is installed at a portion that the motion detection sensor is installed, and the main control part turns on the LED when the motion detection sensor detects a motion signal of the object.
